(19) United States
(12) Patent Application Publication
(10) Pub. No.: US 2009/0254621 A1
(43) Pub. Date: Oct. 8, 2009

(54) PEER-TO-PEER MESSAGING OF FACSIMILE MESSAGES

(75) Inventor: Michael Skowronski, Miami Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: VENALI, INC., Miami, FL (US)

(21) Appl. No.: 12/099,537

(22) Filed: Apr. 8, 2008

(51) Int. Cl. G06F 15/16

(52) U.S. Cl. 709/206

(57) ABSTRACT

Embodiments of the present invention provide a method, system and computer program product for peer-to-peer fax messaging. In an embodiment of the invention, a multi-modal peer-to-peer messaging method can include receiving in a processing node a job request to process a message by way of an ingress node from one type of messaging system for delivery to another type of messaging system by way of an egress node. The method also can include extracting metrics from the job request pertaining to availability of peers to the node and updating a local data store of metrics in the processing node with the extracted metrics. The method yet further can include processing the message according to the job request and setting an availability for the processing node in the local data store of metrics. Finally, the method can include forwarding the processed message and the metrics in the local data store to the egress node for transmission to the different type of messaging system.

### BACKGROUND OF THE INVENTION

1. Field of the Invention

The preset invention relates to the field of message transmission systems and more particularly to facsimile messaging (also referred to as “fax messaging”).

2. Description of the Related Art

Traditionally, documents have been exchanged between parties by way of hand delivery, postal service, or facsimile. More recently, the public Internet has become a highly effective medium through which electronic documents have been exchanged, particularly as attachments to electronic mail. Still, in many occasions, the use of electronic mail cannot provide an adequate medium for document transfer. Specifically, where the original copy of a document is in a hard copy format, with handwritten or non-textual elements, a facsimile device can be the preferred tool of document exchange.

Facsimile devices ordinarily exchange facsimile data with other facsimile devices over the public switched telephone network (PSTN). Specifically, as in the case of an ordinary telephone call, the calling facsimile device can establish a communicative link over the PSTN to a receiving facsimile device. Each of the devices can negotiate suitable data exchange protocols and the transfer of facsimile data can commence. Upon completion of the exchange, the received facsimile data can be transposed to hard copy form and the call can terminate. Notably, like the telephone call, connection charges can apply for the duration of the facsimile communicative link in the same way charges can accrue for a voice call between the same two locations. Where these locations are distance apart, long distance charges may apply.

To circumvent the costs associated with the conventional exchanged of a document between facsimile devices, several technologies have been developed with which facsimile data can be exchanged between facsimile devices not over the PSTN, but over the public Internet. Referred to in the art as “IP faxing”, facsimile data can be packetized and forwarded across the Internet to a network node local to the facsimile recipient. In this way, toll charges ordinarily associated with PSTN based facsimile communications and ordinary telephone calls can be avoided. Consequently, IP faxing has proven to be the bane of fax intensive business processes.

Typical IP fax systems provide for the receipt of fax messages in a fax server and into an unbounded queue. Each inbound fax message is retrieved in turn from the unbounded queue and converted into an attachment to an e-mail message. Thereafter, the e-mail message with attachment can be transmitted to the intended recipient. Optionally, the attachment can be subjected to optical character recognition (OCR) so that an editable fax document can be delivered to the recipient. Outbound fax messages are similarly placed into an unbounded queue as a document and converted in turn into a fax message and transmitted to a destination fax machine.

Thus, it will be apparent to the skilled artisan that traditional IP faxing is highly dependent upon the queuing of fax messages within unbounded queues. In consequence, one can scale an IP faxing system to handle higher transaction volume only by adding new systems with additional unbounded queues. Additionally, to ensure high availability, multiple different fax servers are required in the event that one or more fax servers fail or one or more unbounded queues become crowded. In an unbounded queue of jobs, a single failure can inhibit the processing of the remaining jobs in the unbounded queue.

### BRIEF SUMMARY OF THE INVENTION

Embodiments of the present invention address deficiencies of the art in respect to fax messaging and provide a novel and non-obvious method, system and computer program product for peer-to-peer fax messaging. In an embodiment of the invention, a multi-modal peer-to-peer messaging method can include receiving in a processing node a job request to process a message by way of an ingress node from one type of messaging system for delivery to another type of messaging system by way of an egress node. The method also can include extracting metrics from the job request pertaining to availability of peers to the node and updating a local data store of metrics in the processing node with the extracted metrics. The method yet further can include processing the message according to the job request and setting an availability for the processing node in the local data store of metrics. Finally, the method can include forwarding the processed message and the metrics in the local data store to the egress node for transmission to the different type of messaging system.

In one aspect of the embodiment, the method additionally can include detecting environmental conditions for the processing node indicative of an impending failure, selecting from the local data store of metrics a peer processing node having availability and setting an availability for the processing node in the local data store of metrics, and forwarding the job request to process the message and the metrics in the local data store to the selected peer processing node having availability. In this regard, selecting from the local data store of metrics a peer processing node having availability can include identifying a set of peer processing nodes having availability in the local data store, and randomly selecting one of the peer processing nodes in the set. Finally, in another aspect of the embodiment, processing the message according to the job request can include identifying different workers configured to perform respective tasks requisite to the job such as message branding, message formatting and format conversion, spam processing, billing, least cost routing, acceptable routing, text-to-speech (TTS), automatic speech recognition (ASR) and optical character recognition (OCR), and invoking each of the different workers to process the message.

In another embodiment of the invention, a multi-modal peer-to-peer messaging system can be provided. The system can include a host computing platform communicatively coupled to different messaging systems and multiple nodes arranged in a peer-to-peer architecture and executing in the host computing platform. The nodes can include processing nodes, ingress nodes and egress nodes in that the ingress nodes receive messages to be processed from the different messaging systems, and the egress nodes provide processed messages to be transmitted by the different messaging systems. Further, each of the processing nodes can include a data store of metrics of different peers amongst the processing nodes and respective availabilities, different workers each having been configured to perform a different task in processing a message, and a watchdog service including program code enabled to select a peer processing node to process the message when detected environmental conditions indicate a need to route processing of the message to a peer processing node.

In one aspect of the embodiment, the messaging systems can include at least each of a fax messaging system and an e-mail messaging system. In another aspect of the embodiment, the messaging systems can include at least each of a text messaging system and a voice messaging system. In yet another aspect of the embodiment, the environmental conditions can include conditions such as memory, central processing unit (CPU) performance, and network bandwidth. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of an architecture for a multi-modal peer-to-peer messaging data processing system;

FIG. 2 is a schematic illustration of a processing node configured for use in the multi-modal peer-to-peer messaging data processing system of FIG. 1; and,

FIG. 3 is a flow chart illustrating a process for job management in the processing node of FIG. 2.

### DETAILED DESCRIPTION OF THE INVENTION

Embodiments of the present invention provide a method, system and computer program product for multi-modal peer-to-peer messaging. In accordance with an embodiment of the present invention, a peer-to-peer network of message processing nodes can be established for the distributed processing of multi-modal messages such as fax messages, voice messages, e-mail messages, text messages and the like. Each of the nodes can provide a selection of worker processes configured to perform specific tasks in processing a job, such as fax-to-e-mail conversion, OCR, text-to-speech, ASR, TIFF image rectification, to name only a few tasks. Each of the nodes further can provide a supervisor task configured to select different ones of the workers in order to fully process a job.

Importantly, each node can maintain internal metrics in respect to the availability of the node as well as similar metrics received from peer nodes. In this regard, the metrics can be passed along with messages to other peer nodes within the network. Thus, each node can maintain a partial list of the degree of availability of peer nodes in the network. As each node develops an internal data store of the availability of different peer nodes, the internal data store can be shared amongst the different peer nodes in the ordinary course of message passing between the nodes. Thus, the viral nature of the metrics can ensure both resiliency and also availability in the multi-modal peer-to-peer messaging system.

In operation, a job can be received in a processing node from an ingress node coupled to multiple different messaging systems, for example fax messaging systems, e-mail messaging systems, text messaging systems, and voice messaging systems. The ingress node can be uniquely configured both to identify an available processing node to process an inbound message from a messaging system and also to specify a job requested for processing the message in the processing node. When processing the job within the processing node, environmental conditions for the node and its host platform can be monitored and persisted in the processing node. When a failure occurs or is determined likely to occur imminently within the processing node, a different processing node can be selected from the partial list according to availability and the job can be routed to the selected, different processing node.

Otherwise, the job can be fully processed within the processing node resulting in a result for the job. Thereafter a new availability can be determined for the processing node based upon the environmental conditions. The results from processing the job, in turn, can be provided to an egress node coupled to one or different messaging systems along with the metrics stored within the node. The egress node, similar to the ingress node, can be uniquely configured to identify a messaging system to transmit the results as specified through the ingress node. The metrics provided by the processing node to the egress node ultimately will virally propagate to ingress nodes so that the ingress nodes can account for the availability of the processing node when selecting a processing node to process an inbound job.

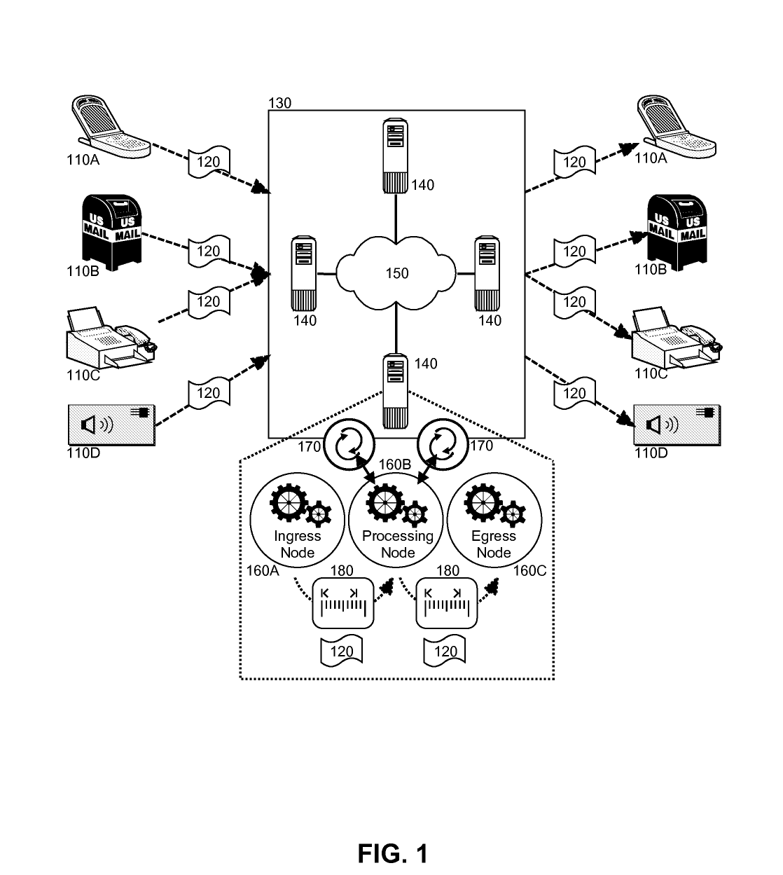

In further illustration, FIG. 1 is a pictorial illustration of an architecture for a multi-modal peer-to-peer messaging data processing system. The system can include a collection of communicatively coupled hosts 140 communicatively coupled to one another over a data communications network 150. Individual ones of the hosts 140 can be configured to receive messages 120 from different messaging systems 110A, 110B, 110C, 110C, 110D, for instance a text messaging system 110A, an e-mail messaging system 110B, a fax messaging system 110C, and a voice messaging system 110D, to name only a few. Correspondingly, individual ones of the hosts 140 can be configured to transmit messages 120 to different messaging systems 110A, 110B, 110C, 110C, 110D.

Each of the hosts 140 can support one or more peer-to-peer networks of processing nodes 160B coupled to both ingress nodes 160A and egress nodes 160C. Specifically, each of the hosts 140 can support one or more VM instances. Each VM in turn can provide a computing environment for an executing one of the nodes 160A, 160B, 160C. The nodes 160A, 160B, 160C can be communicatively coupled to one another in a peer-to-peer arrangement so that the nodes 160A, 160B, 160C can communicate with one another irrespective of the location of each VM instance hosting a corresponding one of the nodes 160A, 160B, 160C.

As shown in FIG. 1, in operation, an inbound message 120 can be provided to an ingress node 160A. The ingress node 160A can identify a job to be performed in processing the message 120 from one messaging system 110A, 110B, 110C, 110D to another messaging system 110A, 110B, 110C, 110D. In this respect, the job selected by the ingress node 160A can enable multi-modal messaging from one mode of messaging, be it fax, voice, text or e-mail, to another mode of messaging. Once the ingress node 160A has selected the job, the ingress node can select a processing node 160B based upon a known availability of the processing node 160B and the ingress node 160A can provide to the processing node 160B each of the message 120, a copy of internal metrics 180 stored in the ingress node 160A, and a script (not shown) directing the job to be performed for the message 120.

Once the processing node 160B has received each of the message 120, a copy of internal metrics 180 stored in the ingress node 160A, and a script (not shown), the processing node 160B can merge the metrics 180 internally. Further, the processing node 160B can determine the tasks requisite to the script (not shown) and the processing node 160B can invoke different workers 170 corresponding to the requisite tasks in order to process the message 120. In this regard, the workers 170 can be invoked utilizing a mechanism to optimize concurrency in execution. For example, an event loop can be utilized, co-routines for similar type operations such as rendering, threads, or as a separate process for more intensive operations such as OCR and format conversion.

The processing node 160B also can update the metrics 180 internally to reflect the availability of the processing node 160B. Thereafter, the processed message 120 can be provided to an egress node 160C along with a copy of internal metrics 180. The egress node 160C in turn can merge the metrics 180 internally and provide egress to the processed message 120 in a messaging system 110A, 110B, 110C, 110D corresponding to the job specified by the ingress node 160A.

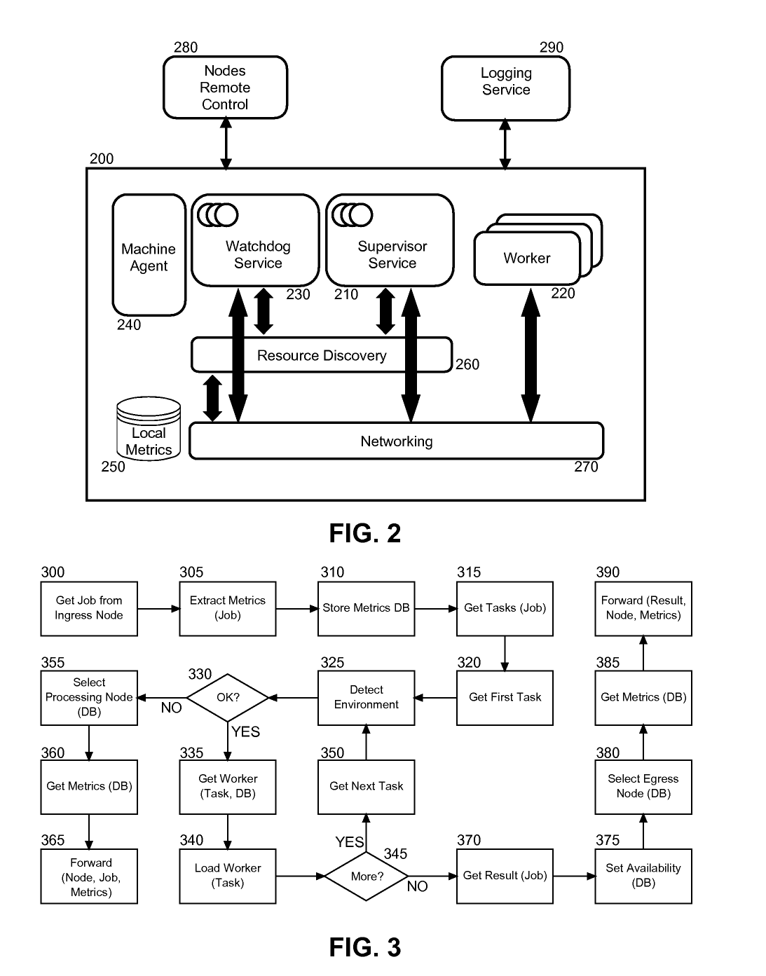

In yet further illustration, FIG. 2 is a schematic illustration of a processing node configured for use in the multi-modal peer-to-peer messaging data processing system of FIG. 1. A processing node 200 can include a supervisor service 210, multiple different workers 220, a watchdog service 230 and a machine agent 240 coupled to an internal data store of metrics 250. The processing node 200 also can include resource discovery logic 260 and networking logic 270. Specifically, the networking logic 270 can provide network communications logic for each of the watchdog service 230, supervisor service 210 and workers 220 in transmitting and receiving messages to other peer nodes.

The resource discovery logic 260 can include program code enabled to locate available peer nodes based upon availability as expressed in the data store of metrics 250. The machine agent 240 in complimentary fashion can extract and process metrics from other peer nodes in order to augment and maintain the data store of local metrics 250. Finally, the watchdog service 230 can include program code enabled to monitor environmental conditions for the processing node 200 and its supporting VM and its host in order to determine when a failure has occurred, or when resources like memory or network bandwidth or drive performance or CPU load have become sufficiently burdened such that the processing node 200 is either likely to fail or perform in a substandard fashion. Consequently, the program code of the watchdog service 230 can be enabled to select a different peer node through resource discovery logic 260 and to pass a job along to the peer node through networking logic 270.

The supervisor service 210 can include program code enabled to receive a message processing job from an ingress node and to determine a selection of the workers 220 to perform the tasks requisite to the job. For example, the tasks requisite to the job can be provided in a script from the ingress node, or in a script corresponding to a directive provided by the ingress node. The workers 220, in turn, can include discrete program code to perform a specific task. Exemplary tasks include message branding, message formatting and format conversion, spam processing, billing, least cost routing, acceptable routing, TTS, ASR and OCR. Optionally, nodes remote control 280 can be provided to remotely manage a processing node 200 for maintenance and diagnostics, and a logging service 290 can be provided to acquire logging of the performance of the processing node 200.

In even yet further illustration, FIG. 3 is a flow chart illustrating a process for job management in the processing node of FIG. 2. Beginning in block 300, a job including a message can be received from an ingress node and in block 305, metrics can be extracted from the job. In block 310, the internal metrics of the processing node can be updated with the extracted metrics. In block 315, one or more tasks can be determined for the job and in block 320, a first task can be selected. In block 325, environmental conditions can be detected and in decision block 330 it can be determined whether or not the processing node can continue to process the job. If not, in block 355 a new processing node can be located by reference to the internal metrics and the internal metrics for the current processing node can be retrieved in block 360. For example, a selection of the most available peer nodes can be determined and one of the peer nodes in the selection can be randomly chosen to be the new processing node. In this regard, the randomization of the selection of a peer node accommodates the power-law distribution nature of the peer-to-peer architecture and empowers the peer-to-peer architecture to be intrinsically self-regulating. Finally, in block 365 each of the job and the retrieved metrics can be forwarded to the new processing node.

By comparison, in decision block 330, if it is determined that the processing node can continue to process the job, the process can continue through block 335 with the selection of a worker to perform the task and in block 340 with the loading and execution of the worker to perform the task. In decision block 345, if additional tasks remain to be performed for the job, in block 350 a next task can be selected and the process can repeat through block 325. In decision block 345, when no further tasks remain for the job, in block 370 the processed message can be loaded and in block 375 the availability for the processing node can be set.

In this regard, to avoid the wanton exhaustion of each of the processing nodes, the availability of a given processing node can be set to a lower value subsequent to processing a job in order to encourage the “resting” of the processing node. Further, when detected environmental conditions warrant, the availability of a given processing node can be set to a substantially lower value subsequent to processing a job in order to force the “resting” of the processing node. In this way, the performance of the entire peer-to-peer network can be throttled to minimize failure conditions and to smooth the utilization of different processing nodes in the peer-to-peer network. In any event, in block 380, an egress node can be located from the internal metrics and the internal metrics can be loaded in block 385. In block 390, the processed message and the internal metrics can be forwarded to the located egress node which in turn can pass the message to a suitable messaging system.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A multi-modal peer-to-peer messaging method comprising:
receiving in a processing node a job request to process a message by way of an ingress node from one type of messaging system for delivery to a different type of messaging system by way of an egress node;
extracting metrics from the job request pertaining to availability of peers to the node and updating a local data store of metrics in the processing node with the extracted metrics;
processing the message according to the job request and setting an availability for the processing node in the local data store of metrics; and,
forwarding the processed message and the metrics in the local data store to the egress node for transmission by the different type of messaging system.

2. The method of claim 1, further comprising:
detecting environmental conditions for the processing node indicative of an impending failure;
selecting from the local data store of metrics a peer processing node having availability and setting an availability for the processing node in the local data store of metrics; and,
forwarding the job request to process the message and the metrics in the local data store to the selected peer processing node having availability.

3. The method of claim 1, wherein selecting from the local data store of metrics a peer processing node having availability, comprises:
identifying a set of peer processing nodes having availability in the local data store; and,
randomly selecting one of the peer processing nodes in the set.

4. The method of claim 1, wherein the one type of messaging system comprises a messaging system selected from the group consisting of a fax messaging system, a text messaging system, an e-mail messaging system and a voice messaging system.

5. The method of claim 1, wherein the different type of messaging system comprises a messaging system selected from the group consisting of a fax messaging system, a text messaging system, an e-mail messaging system and a voice messaging system.

6. The method of claim 1, wherein the environmental conditions comprise conditions selected from the group consisting of memory, central processing unit (CPU) performance, and network bandwidth.

7. The method of claim 1, wherein processing the message according to the job request, comprises:
identifying a plurality of different workers configured to perform respective tasks requisite to the job; and,
invoking each of the different workers to process the message.

8. The method of claim 7, wherein the tasks are tasks selected from the group consisting of message branding, message formatting and format conversion, spam processing, billing, least cost routing, acceptable routing, text-to-speech (TTS), automatic speech recognition (ASR) and optical character recognition (OCR).

9. A multi-modal peer-to-peer messaging system comprising:
a host computing platform communicatively coupled to a plurality of different messaging systems; and,
a plurality of nodes arranged in a peer-to-peer architecture and executing in the host computing platform, the nodes comprising processing nodes, ingress nodes and egress nodes, the ingress nodes receiving messages to be processed from the different messaging systems, the egress nodes providing processed messages to be transmitted by the different messaging systems;
wherein each of the processing nodes comprises a data store of metrics of different peers amongst the processing nodes and respective availabilities, a plurality of workers, each configured to perform a different task in processing a message, and a watchdog service comprising program code enabled to select a peer processing node to process the message when detected environmental conditions indicate a need to route processing of the message to a peer processing node.

10. The system of claim 9, wherein the messaging systems comprise at least each of a fax messaging system and an e-mail messaging system.

11. The system of claim 9, wherein the messaging systems comprise at least each of a text messaging system and a voice messaging system.

12. The system of claim 9, wherein the environmental conditions comprise conditions selected from the group consisting of memory, central processing unit (CPU) performance, and network bandwidth.

13. A computer program product comprising a computer usable medium embodying computer usable program code for multi-modal peer-to-peer messaging, the computer program product comprising:
computer usable program code for receiving in a processing node a job request to process a message by way of an ingress node from one type of messaging system for delivery to a different type of messaging system by way of an egress node;
computer usable program code for extracting metrics from the job request pertaining to availability of peers to the node and updating a local data store of metrics in the processing node with the extracted metrics;
computer usable program code for processing the message according to the job request and setting an availability for the processing node in the local data store of metrics; and,
computer usable program code for forwarding the processed message and the metrics in the local data store to an egress node for transmission by the different type of messaging system.

14. The computer program product of claim 13, further comprising:
computer usable program code for detecting environmental conditions for the processing node indicative of an impending failure;
computer usable program code for selecting from the local data store of metrics a peer processing node having availability and setting an availability for the processing node in the local data store of metrics; and,
computer usable program code for forwarding the job request to process the message and the metrics in the local data store to the selected peer processing node having availability.

15. The computer program product of claim 13, wherein the computer usable program code for selecting from the local data store of metrics a peer processing node having availability, comprises:
computer usable program code for identifying a set of peer processing nodes having availability in the local data store; and,
computer usable program code for randomly selecting one of the peer processing nodes in the set.

16. The computer program product of claim 13, wherein the one type of messaging system comprises a messaging system selected from the group consisting of a fax messaging system, a text messaging system, an e-mail messaging system and a voice messaging system.

17. The computer program product of claim 13, wherein the different type of messaging system comprises a messaging system selected from the group consisting of a fax messaging system, a text messaging system, an e-mail messaging system and a voice messaging system.

18. The computer program product of claim 13, wherein the environmental conditions comprise conditions selected from the group consisting of memory, central processing unit (CPU) performance, and network bandwidth.

19. The computer program product of claim 13, wherein the computer usable program code for processing the message according to the job request, comprises:
computer usable program code for identifying a plurality of different workers configured to perform respective tasks requisite to the job; and,
computer usable program code for invoking each of the different workers to process the message.

20. The computer program product of claim 19, wherein the tasks are tasks selected from the group consisting of message branding, message formatting and format conversion, spam processing, billing, least cost routing, acceptable routing, text-to-speech (TTS), automatic speech recognition (ASR) and optical character recognition (OCR).
